(19) United States
(12) Patent Application Publication
(10) Pub. No.: US 2015/0221494 A1
(43) Pub. Date: Aug. 6, 2015

(54) Crucible for a LUWPL

(71) Applicant: CERAVISION LIMITED, Buckinghamshire (GB)

(72) Inventor: Barry Preston, Leicestershire (GB)

(21) Appl. No.: 14/429,010

(22) PCT Filed: Sep. 19, 2013
(86) PCT No.: PCT/GB2013/052462

§ 371 Date: Mar. 18, 2015

(30) Foreign Application Priority Data
Sep. 19, 2012 (GB) 1216755.7

(51) Int. Cl. H01J 65/04; H01J 61/30; H01J 9/24

(52) U.S. Cl. CPC H01J 65/04; H01J 9/247; H01J 61/30

(57) ABSTRACT

A crucible for a LUWPL is formed from a wave guide body having a central bore through it. Received within the central bore is a drawn quartz tube having its ends sealed, one having been worked flat to be coplanar with one face of the body. The other end has a vestigial tip. This is secured to the body at the orifice of the bore in the other face of the body. The securement is by means of ceramic adhesive compound.

The present invention relates to a crucible for a LUWPL, that is a Lucent waveguide Plasma Light source.

In European Patent No EP1307899, granted in our name there is claimed a light source comprising a waveguide configured to be connected to an energy source and for receiving electromagnetic energy, and a bulb coupled to the waveguide and containing a gas-fill that emits light when receiving the electromagnetic energy from the waveguide, characterised in that:
(a) the waveguide comprises a body consisting essentially of a dielectric material having a dielectric constant greater than 2, a loss tangent less than 0.01, and a DC breakdown threshold greater than 200 kilovolts/inch, 1 inch being 2.54 cm,
(b) the wave guide is of a size and shape capable of supporting at least one electric field maximum within the wave guide body at at least one operating frequency within the range of 0.5 to 30 GHz,
(c) a cavity depends from a first side of the waveguide,
(d) the bulb is positioned in the cavity at a location where there is an electric field maximum during operation, the gas-fill forming a light emitting plasma when receiving microwave energy from the resonating waveguide body, and
(e) a microwave feed positioned within the waveguide body is adapted to receive microwave energy from the energy source and is in intimate contact with the waveguide body.

In our European Patent No 2,188,829 there is described and claimed a light source to be powered by microwave energy, the source having:
a body having a sealed void therein,
a microwave-enclosing Faraday cage surrounding the body,
   the body within the Faraday cage being a resonant waveguide,
a fill in the void of material excitable by microwave energy to form a light emitting plasma therein, and
an antenna arranged within the body for transmitting plasma-inducing, microwave energy to the fill, the antenna having:
   a connection extending outside the body for coupling to a source of microwave energy;
      wherein:
the body is a solid plasma crucible of material which is lucent for exit of light therefrom, and
the Faraday cage is at least partially light transmitting for light exit from the plasma crucible,
   the arrangement being such that light from a plasma in the void can pass through the plasma crucible and radiate from it via the cage.

We refer to this as our Light Emitting Resonator or LER patent. Its main claim as immediately above is based, as regards its prior art portion, on the disclosure of our EP1307899, first above.

In our European Patent Application No 08875663.0, published under No WO2010055275, there is described and claimed a light source comprising:
a lucent waveguide of solid dielectric material having:
   an at least partially light transmitting Faraday cage surrounding the waveguide, the Faraday cage being adapted for light transmission radially,
   a bulb cavity within the waveguide and the Faraday cage and
   an antenna re-entrant within the waveguide and the Faraday cage and
a bulb having a microwave excitable fill, the bulb being received in the bulb cavity.

We refer to this as our Clam Shell application, in that the lucent wave guide forms a clam shell around the bulb.

As used in our LER patent, our Clam Shell application and this specification:
“microwave” is not intended to refer to a precise frequency range. We use “microwave” to mean the three order of magnitude range from around 300 MHz to around 300 GHz;
“lucent” means that the material, of which an item described as lucent is comprised, is transparent or translucent;
“plasma crucible” means a closed body enclosing a plasma, the latter being in the void [in the body] when the void's fill is excited by microwave energy from the antenna;
“Faraday cage” means an electrically conductive enclosure of electromagnetic radiation, which is at least substantially impermeable to electromagnetic waves at the operating, i.e. microwave, frequencies.

The LER patent, the Clam Shell Application and certain LER improvement applications have in common that they are in respect of:

A microwave plasma light source having:
a Faraday cage:
   delimiting a waveguide and
   being at least partially lucent, and normally at least partially transparent, for light emission from it, and
   normally having a non-lucent closure;
a body of solid-dielectric, lucent material embodying the waveguide within the Faraday cage;
a closed void in the waveguide containing microwave excitable material; and
provision for introducing plasma exciting microwaves into the waveguide;
   the arrangement being such that on introduction of microwaves of a determined frequency a plasma is established in the void and light is emitted via the Faraday cage.

In our patent application No. PCT/GB2011/001744 (our '744 Application), we defined an LUWPL as follows:

A microwave plasma light source having:
a fabrication of solid-dielectric, lucent material, having;
   a closed void containing electro-magnetic wave, normally microwave, excitable material; and
a Faraday cage:
   delimiting a waveguide,
   being at least partially lucent, and normally at least partially transparent, for light emission from it,
   normally having a non-lucent closure and
   enclosing the fabrication;
provision for introducing plasma exciting electro-magnetic waves, normally microwaves, into the waveguide;
   the arrangement being such that on introduction of electro-magnetic waves, normally microwaves, of a determined frequency a plasma is established in the void and light is emitted via the Faraday cage.

In the preferred embodiment of our LER patent, the void is formed directly in the lucent waveguide, which is generally a quartz body. This exposes the quartz material to high temperatures by radiation from the plasma and conduction from the gases surrounding the plasma. It is because of this exposure that the term “solid plasma crucible” is used in the LER patent, a crucible being a container for high temperature material. This exposure can result in problems if the plasma causes micro-cracking of the material of the crucible, which then propagate through it.

In our Clam Shell application, this problem is not so apparent in that a quartz bulb having the void and excitable material is provided distinct from and inserted into the lucent wave guide. The waveguide may be formed of two halves captivating the bulb between them or a single body having a bore in which the bulb is received.

In our UK application No 116224.5 we have disclosed a crucible for a LUWPL, the crucible comprising:
a waveguide body of lucent material having a bore;
a tube of lucent material is provided in the bore, the tube:
   being closed at both ends,
   containing the excitable material in a void formed in its bore between its sealed ends and
   being in intimate contact with the lucent material of the body.

Whilst we are confident that providing intimate contact between the tube and the body is feasible in volume production, initial trials have provided inconsistent results. We attribute this to tolerances. Where the tube and the bore are dimensionally close, it has been possible to inflate the tube against the bore, achieving satisfactory intimate contact and long life. However where the tolerances are such that the tube requires to be inflated across too large an annular space, poor contact results. In operation with poor tube/body contact life is short, with Faraday cage surrounding the crucible disintegrating close to where the vestigial end of the tube passes through the cage.

Despite it providing contact between the tube and the body only in a limited area, we have been surprised to note a significant improvement in life if the tube is attached to the body at its vestigial end by frit or ceramic adhesive.

The object of the present invention is to provide an improved crucible for a LUWPL of the LER type.

According to a first aspect of the invention there is provided a crucible for a LUWPL, the crucible comprising:
a waveguide body of lucent material having a bore;
a tube of lucent material is provided in the bore, the tube:
   being closed at both ends,
   containing the excitable material in a void formed in its bore between its sealed ends,
   being accommodated with a sliding fit annular gap in the bore of the body and
   secured in the body by bonding material at an orifice of the bore.

By “sliding fit annular gap” is meant that the tube would be free to slide in the bore were it not secured by the bonding material.

The bonding material can be provided continuously around the 360° of the orifice, in a ring, or at a plurality of discrete positions around the orifice.

Preferably the bonding material is a “thermal bonding material”, whereby the bonding material requires an increase in temperature for bonding to occur. Typically the thermal bonding material will require an increase in temperature to between 200° C. and 1600° C. and ideally to a temperature below the softening point of the crucible and tube.

It is envisaged that the thermal bonding material may through chemical reaction, however preferably the bonding material requires the application of an external heat source to increase the temperature.

By “thermal bonding material” is meant to include, but is not limited to:
a frit, typically comprising a ceramic composition, preferably a mixture of oxides, that has been fused in an oven, quenched rapidly and granulated or ground to a powder;
a mixture of oxides, typically granulated or ground to a powder but not processed to a frit; and
a ceramic adhesive, preferably a phosphate silica filled ceramic adhesive such as Aremco Ceramabond 618.

Where the bonding material is a frit or a mixture of oxides not processed to a frit, typically the bonding material has a low expansion coefficient and a melting temperature above the operational temperature of the bonded surfaces of the tube and waveguide body.

Where the thermal bonding material a frit comprised of a mixture of oxides, typically the melting temperature of the frit is lower than the melting temperature of the corresponding mixture when not processed to a frit.

Where the thermal bonding material is ceramic adhesive, typically the adhesive is heated to a temperature around 400° C. during manufacture of the crucible and has a bond strength that increases when the bonded surfaces are exposed to temperatures in excess of 400° C. during operation.

According to a second aspect of the invention there is provided a method in the manufacture of the crucible of the first aspect including the steps of:
providing a lucent waveguide body with a bore therein;
inserting a lucent tube in the bore; and
securing the tube in the body by bonding material at an orifice of the bore.

Whilst the tube could be sealed after it has been secured in the body, we prefer to seal it before it is inserted in the bore. To this extent the tube is in effect a bulb when secured into the body.

It is envisaged that where the bonding material is a thermal bonding material, the step of securing the tube in the body may further comprise the steps of:
applying a ring or segments of the fusible material to the surfaces to be secured; and
heating the material.

It is envisaged that the heating step may be performed by a flame or a laser applied directly to the material. Alternatively, the crucible may be placed in a furnace to heat and melt the material.

The heating and melting step may be performed in a vacuum or in an inert atmosphere, but is preferably performed in ambient air.

Whilst the material may be heated before it is applied to the surfaces to be secured, typically by melting a pressed rod of the material with a flame and applying directly to the surfaces, we prefer to apply the material before heating.

Where the thermal bonding material is a frit or a mixture of oxides not processed to a frit, the securing step may further include the step of pressing the material into a ring or a plurality of segments, preferably before applying to the surfaces to be secured.

To help understanding of the invention, a specific embodiment thereof will now be described by way of example and with reference to the accompanying drawings, in which:

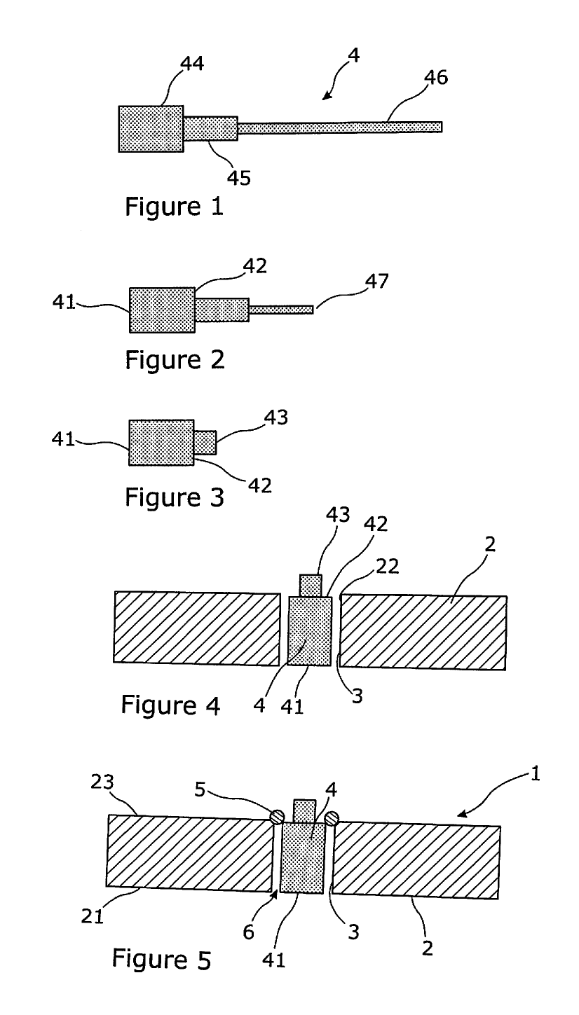

FIG. 1 is a side view of a compound tube for use in forming a capsule or bulb in a crucible of the invention for a LUWPL;

FIG. 2 is a similar side view showing the tube after preliminary sealing to enclose noble gas and excitable material;

FIG. 3 is a further similar view showing the tube tipped off to form a bulb or capsule;

FIG. 4 is a cross-sectional side view of the bulb or capsule in a crucible; and

FIG. 5 is a similar view showing securement of the bulb in the crucible.

Referring to the drawings, a crucible 1 of the invention is formed from a wave guide body 2 of fused quartz, typically it is 49 mm in diameter and 20 mm long for operation in a Faraday cage closely enclosing it at a microwave resonance of 2.45 GHz. It has a central bore 3 of 10.5 mm diameter through it, which is polished to optical clarity, but not to the extent of reasonable certainty of removal of all micro-cracks resultant from the process of boring. It also has an eccentric bore for receiving an antenna for introducing microwaves.

Received within the central bore is a drawn quartz tube 4 of 3 mm nominal wall thickness, i.e. 10 mm nominal outside diameter. The tube is a sliding fit in the bore for all normal tolerance sizes of the tube. It has its ends sealed, one 41 having been worked flat to be coplanar with one face 21 of body. The other end 42 has a vestigial tip 43. This is secured to the body at the orifice 22 of the bore in the other face 23 of the body. The securement is by means of ceramic adhesive compound 5, typically a phosphate silica filled ceramic adhesive such as Aremco Ceramabond 618, that has strength for component handling after 4 hours of air drying and working strength after heat soak at 200° C. The ceramic adhesive compound preferably extends as a fillet through 360°. However it is believed that 360° arcs of fillet will suffice.

The tube is pre-filled, prior to securement, with excitable material as follows:
1. Whilst the 10 mm tube is of a length 44 equivalent to the thickness of the body, it was fused to a piece of intermediate, 8 mm diameter 45, with a further length of 6 mm diameter tube 46 fused to it;
2. It is sealed and worked flat at its end 41;
3. The combined tube is evacuated and excitable material with noble gas introduced into it. After gas introduction, the tube is sealed at a tip off 47 in the 6 mm portion. The introduction process can include a step of purging impurity from the material by heating at the end 41, with the impurity evacuating and the charge condensing on a cool part of the tube;
4. After preliminary sealing, the region of the where charge has condensed is heated to chase the material back to the now cool end 41. The tube is sealed again at the 8 mm portion and worked in a glass lathe to have a small tip 43.

It has been found that despite the almost inevitable presence of an annular air gap 6 between the bore 3 and the tube, the securement provided by the ceramic adhesive allows the crucible to operate satisfactorily in a LUWPL.

The invention is not intended to be restricted to the details of the above described embodiment. For instance, a frit or a mixture of oxides not processed to a fit may be used to secure the tube to the waveguide body, whereby heating and melting of the frit or mixture of oxides will form a glassy interface between the tube and the waveguide. Alternatively, another bonding material may be used to secure the tube to the waveguide body.

The bonding material may be a paste or a solid and may be applied to the tube and waveguide, around the orifice of the bore, in a complete ring or in a plurality of discrete fillets before the waveguide, tube and bonding material arrangement is heated in a furnace. For ceramic adhesive, the bonding material is typically heated to 400° C. in ambient air, the bond strength increasing when the material is exposed to temperatures in excess of this during operation. For a frit or a mixture of metal oxides, the bonding material is typically heated to above the melting temperature of the frit or mixture, but not above the softening temperature of the waveguide body or the tube, typically around 1600° C. Alternatively, the bonding material may be heated directly by a flame or a laser whilst in situ. Alternatively, the bonding material may be heated before being applied to the waveguide and tube at the surfaces to be bonded, typically by a flame in a similar manner to flame soldering. Certain bonding materials may not require the step of heating or may require the further step of pressing.

Securing of the tube to the waveguide body may be performed in an inert atmosphere or in a vacuum, but preferably is carried out in ambient air.

1. A crucible for a LUWPL, the crucible comprising:
a waveguide body of lucent material having a through bore;
a tube of lucent material is provided in the bore, the tube:
being closed at both ends,
containing the excitable material in a void formed in its bore between its sealed ends,
being accommodated with a sliding fit annular gap in the bore of the body and
secured in the body by bonding material at an orifice of the bore.

2. A crucible as claimed in claim 1, wherein the bonding material is provided continuously around the three-hundred and sixty degrees of the orifice.

3. A crucible as claimed in claim 1, wherein the bonding material is provided at a plurality of discrete positions around the orifice.

4. A crucible as claimed in claim 1, wherein the bonding material is a thermal bonding material.

5. A crucible as claimed in claim 4, wherein the thermal bonding material is a frit.

6. A crucible as claimed in claim 4, wherein the thermal bonding material is a mixture of oxides, not processed into a frit.

7. A crucible as claimed in claim 4, wherein the thermal bonding material is a ceramic adhesive.

8. A crucible as claimed in claim 1, wherein the tube is a sealed plasma bulb.

9. A method in the manufacture of the crucible of claim 1, comprising the steps of:
providing a lucent waveguide body with a bore therein;
inserting a lucent tube in the bore; and
securing in the body by bonding material at an orifice of the bore.

10. A method as claimed in claim 9, wherein the tube is sealed after it has been secured in the body.

11. A method as claimed in claim 9, wherein the tube is sealed before it is inserted in the bore.

12. A method as claimed in claim 9, wherein the bonding material is a thermal bonding material.

13. A method as claimed in claim 12, wherein the step of securing the tube in the body further comprises the steps of:
applying a ring or segments of the fusible material to the surfaces to be secured; and
heating the material.

14. A method as claimed in claim 13, wherein the heating step is performed before the material is applied to the surfaces to be secured.

15. A method as claimed in claim 13, wherein the heating step is performed after the material is applied to the surfaces to be secured.

16. A method as claimed in claim 13, wherein the heating step comprises heating the material by a flame.

17. A method as claimed in claim 13, wherein the heating step comprises heating the material by a laser.

18. A method as claimed in claim 13, wherein the heating step comprises heating the waveguide, tube and material by a furnace.

19. A method as claimed in claim 13, wherein the securing step may further include the step of pressing the material into a ring or a plurality of segments, preferably before applying to the surfaces to be secured.

20. A method as claimed in claim 9, wherein the tube is a sealed plasma bulb.
